(19) United States
(12) Patent Application Publication
(10) Pub. No.: US 2026/0178922 A1
(43) Pub. Date: Jun. 25, 2026

(54) METHOD AND SYSTEM FOR FINE-TUNING VISION FOUNDATION MODELS THAT CAN UTILIZE TRAINING DATA CONTAINING LABEL NOISE

(71) Applicant: GWANGJU INSTITUTE OF SCIENCE AND TECHNOLOGY, Gwangju (KR)

(72) Inventors: Kyoobin LEE, Gwangju (KR); Yeon Guk YU, Gwangju (KR); Min Hwan KO, Gwangju (KR); Kang Min KIM, Gwangju (KR); Sung Ho SHIN, Gwangju (KR)

(73) Assignee: GWANGJU INSTITUTE OF SCIENCE AND TECHNOLOGY, Gwangju (KR)

(21) Appl. No.: 19/360,384

(22) Filed: Oct. 16, 2025

(30) Foreign Application Priority Data
Dec. 20, 2024 (KR) 10-2024-0192803

(51) Int. Cl. G06N 3/09

(52) U.S. Cl. CPC G06N 3/09

(57) ABSTRACT

Disclosed herein is a fine-tuning method including: confirming training data composed of input data and ground-truth data labeled for the input data; training a linear layer parameter of a pre-trained foundation model using the training data; extracting, from the training data, filtering data in which a pair of the input data and the ground-truth data satisfies a predefined matching condition, based on the foundation model in which the linear layer parameter is trained according to the training data; and training an adapter parameter for the foundation model using the filtering data.

### CROSS REFERENCE TO RELATED APPLICATION

The present application claims priority to Korean Patent Application No. 10-2024-0192803, filed Dec. 20, 2024, the entire contents of which are hereby incorporated by reference in its entirety.

### STATEMENT REGARDING PRIOR DISCLOSURES BY THE INVENTOR OR A JOINT INVENTOR

Prior disclosure related to the present application was made by inventors of the present application in journal paper entitled “Curriculum Fine-tuning of Vision Foundation Model for Medical Image Classification Under Label Noise” on Nov. 29, 2024. A copy of the journal paper is provided on a concurrently filed Information Disclosure Statement.

### BACKGROUND OF THE INVENTION

### Field of the Invention

The disclosed embodiments relate to a method and system for fine-tuning vision foundation models that can utilize training data containing label noise.

### Description of the Related Art

Recently, a vision-based deep neural network has exhibited excellent performance in various tasks such as classification, detection, and segmentation. For example, in the medical fields, research is actively being conducted on learning models that can detect and classify lesions or medical conditions from images captured by skin imaging devices, X-Ray, magnetic resonance imaging (MRI), computed tomography (CT), etc., based on a large number of images with specific labels.

However, data for actually training the deep neural network sometimes includes noise labels. The noise labels indicate cases where training images and ground-truth data are incorrectly connected or inconsistent. In particular, the noise labels cause significant performance degradation in the deep neural networks as ground-truth labeled for training images becomes more complex.

In this regard, an algorithm has been proposed to prevent performance degradation due to noise labels. The algorithm is based on the fact that, during the learning process of the deep neural network, the smaller the amount of loss, the faster the classification and training of the training data becomes, and thus, uses two different homogeneous networks to select and provide training data with lower loss. The algorithm uses the training data to perform training, thereby preventing the performance degradation due to the noise labels.

### SUMMARY OF THE INVENTION

The disclosed embodiments are intended to provide a method and system for fine-tuning vision foundation models that can utilize training data containing label noise capable of performing fine-tuning on a pre-trained foundation model based on large-scale training data so that the pre-trained foundation model can be used as a vision-based model for a specific field.

In addition, the disclosed embodiments are intended to provide a method and system for fine-tuning vision foundation models that can utilize training data containing label noise, capable of providing a more powerful fine-tuned learning model for a specific field corresponding to training data.

There is provided a fine-tuning method according to an embodiment. The fine-tuning method may include: confirming training data composed of input data and ground-truth data labeled for the input data; training a linear layer parameter of a pre-trained foundation model using the training data; extracting, from the training data, filtering data in which a pair of the input data and the ground-truth data satisfies a predefined matching condition, based on the foundation model in which the linear layer parameter is trained according to the training data; and training an adapter parameter for the foundation model using the filtering data.

There is provided a fine-tuning system according to an embodiment. The fine-tuning system may include: a storage unit storing training data composed of input data and ground-truth data labeled for the input data; and a control unit performing fine-tuning on a pre-trained foundation model using the training data, in which the control unit trains a linear layer parameter of the pre-trained foundation model using the training data, extracts, from the training data, filtering data in which a pair of the input data and the ground-truth data satisfies a predefined matching condition, based on the foundation model in which the linear layer parameter is trained according to the training data, and trains an adapter parameter for the foundation model using the filtering data.

There is provided a program stored in a computer-readable recording medium according to an embodiment, executed by one or more processes in an electronic device. The program may include instructions to perform: confirming training data composed of input data and ground-truth data labeled for the input data; training a linear layer parameter of a pre-trained foundation model using the training data; extracting, from the training data, filtering data in which a pair of the input data and the ground-truth data satisfies a predefined matching condition, based on the foundation model in which the linear layer parameter is trained according to the training data; and training an adapter parameter for the foundation model using the filtering data.

According to the method and system for fine-tuning vision foundation models that can utilize training data containing label noise according to various embodiments of the present invention, by training the linear layer parameters and adapter parameters of the pre-trained foundation model using the training data from the specific field, it is possible to perform the fine-tuning on the pre-trained foundation model based on the large-scale training data so that the pre-trained foundation model can be used as the vision-based model for the specific field.

In addition, according to the method and system for fine-tuning vision foundation models that can utilize training data containing label noise according to various embodiments of the present invention, by filtering the noise ground-truth data from the training data containing noise and training the linear layer parameters and the adapter parameters step by step, it is possible to provide a more powerful fine-tuned learning model for the specific field corresponding to the training data.

### BRIEF DESCRIPTION OF THE DRAWINGS

FIG. 1 illustrates an embodiment of training a foundation model.

FIG. 2 illustrates a fine-tuning system according to the present invention.

FIG. 3 is a flowchart illustrating a fine-tuning method according to the present invention.

FIG. 4 illustrates an embodiment of training data.

FIG. 5 illustrates an embodiment of training a linear layer parameter.

FIG. 6 illustrates an embodiment of extracting filtering data.

FIG. 7 illustrates an embodiment of training an adapter parameter.

FIG. 8 illustrates an embodiment of extracting additional filtering data.

FIG. 9 illustrates an embodiment of training an additional adapter parameter.

FIG. 10 illustrates an embodiment of a fine-tuned foundation model.

FIG. 11 is a block diagram illustrating an embodiment of a computing system in which the present invention may be implemented.

FIGS. 12 and 13 are block diagrams illustrating an embodiment of a computing device according to the present invention.

### DETAILED DESCRIPTION OF THE INVENTION

Hereafter, embodiments described in the present specification will be described in detail with reference to the accompanying drawings and the same or similar components are given the same reference numerals regardless of reference numerals and are not repeatedly described. The words “module” and “unit” used for components in the following description are given or used interchangeably only for the convenience of writing the specification, and do not have distinct meanings or roles in themselves. Further, in describing the embodiments disclosed in the present specification, when it is determined that a detailed description for the known art related to the present invention may obscure the gist of the embodiments described in the present specification, the detailed description will be omitted. Further, it should be understood that the accompanying drawings are provided only in order to allow the embodiments described in the present specification to be easily understood, and the spirit of the present invention is not limited by the accompanying drawings, but includes all the modifications, equivalents, and substitutions included in the spirit and the scope of the present invention.

Terms including ordinal numbers such as “first,” “second,” etc., may be used to describe various components, but the components are not to be construed as being limited to the terms. The terms are only used to differentiate one component from other components.

It is to be understood that when a component is referred to as being “connected to” or “coupled to” another component, it may be connected directly to or coupled directly to another element or be connected to or coupled to another element, having other components intervening therebetween. On the other hand, it should be understood that when one component is referred to as being “connected directly to” or “coupled directly to” another component, it may be connected to or coupled to another component without other components interposed therebetween.

Singular expressions are intended to include plural expressions unless the context clearly indicates otherwise.

It will be further understood that terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

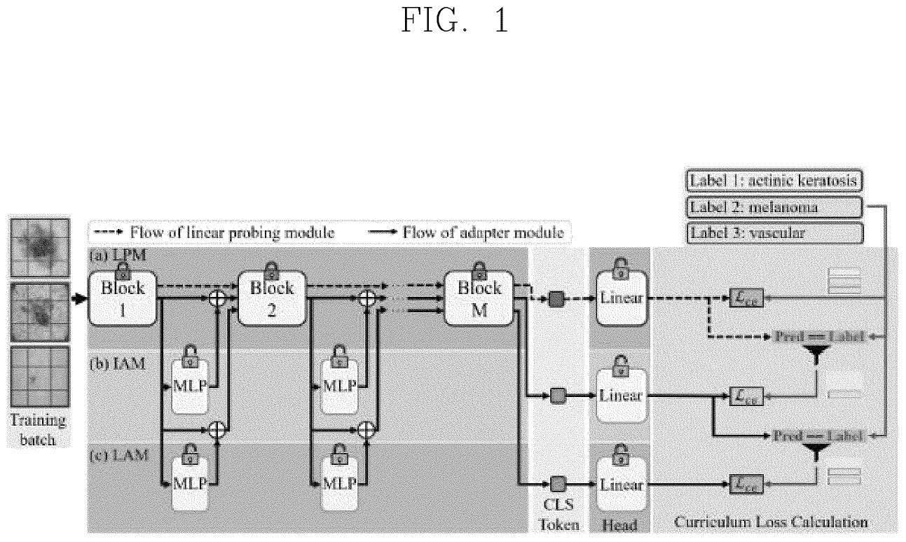

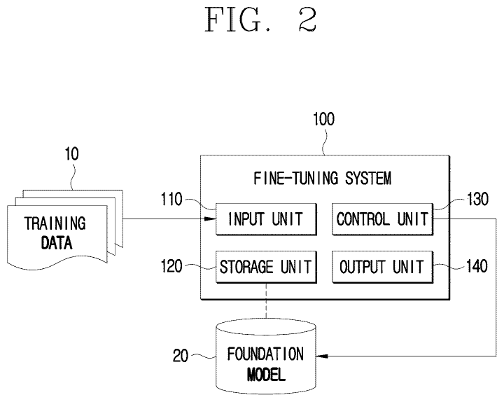

FIG. 1 illustrates an embodiment of training a foundation model. FIG. 2 illustrates a fine-tuning system according to the present invention.

Referring to FIG. 1, a fine-tuning system 100 according to the present invention may perform fine-tuning on a pre-trained foundation model using training data. Here, “fine-tuning” may refer to a process of re-training the pre-trained base model using new training data so that the model parameters, initialized from the pre-trained base model, are adapted to a specific application domain or purpose.

To this end, the fine-tuning system 100 may train a linear layer parameter of a pre-trained foundation model using training data, extract filtering data from the training data based on a foundation model in which the linear layer parameter has been trained, and train an adapter parameter loaded into the foundation model using the filtering data.

Here, the foundation model (e.g., vision foundation models (VFM)) is a pre-trained model based on large-scale training data, and when an image or video is input, may be trained to achieve the purpose of various vision tasks, such as classifying or extracting a specific object from the input image or video, or classifying the image or video by predetermined object.

For example, the foundation model may include a model, based on various neural network architectures, such as a vision transformer (ViT), contrastive language-image pre-training (CLIP), masked autoencoders for pretraining (MAE), and distillation with no labels (DINO).

The training data may be prepared to fine-tune the pre-trained foundation model based on the large-scale training data according to a predefined field. Here, the predefined field may mean a field that will acquire predetermined results through a vision-based foundation model, and may include various fields such as medical, construction, electronics, IT, and big data. Therefore, the training data may be configured differently depending on the purpose of fine-tuning the foundation model.

In addition, the training data may include clean ground-truth data in which output data output through the foundation model in response to input data and ground-truth data have been labeled identically, and noise ground-truth data in which the output data and the ground-truth data have been labeled differently. In this case, the ground truth data may refer to a target output value (label, target value) that the model is intended to predict in correspondence with the input data.

Here, the clean ground-truth data may indicate that the input data is accurately labeled with the ground-truth data to align with the intention or purpose of training through the foundation model, and the noise ground-truth data may indicate that the input data is labeled with incorrect ground-truth data that is different from the intention or purpose of training through the foundation model.

For example, when fine-tuning the foundation model to detect a name of a lesion from an image obtained by capturing a lesion on a human body, the ground-truth data that has the same name as that of the lesion captured in the image may be the clean ground-truth data, and the ground-truth data that has a different name from that of the lesion captured in the image may be the noise ground-truth data.

The filtering data may be data obtained by filtering the training data according to a predefined condition. That is, the filtering data may be composed of at least some data extracted from the training data.

Here, the predefined condition for extracting the filtering data from the training data may be predefined as a matching condition, and the matching condition may be determined to indicate a case where the output data output by inputting the predetermined input data to the foundation model and the ground-truth data labeled for the corresponding input data are identical.

That is, the filtering data may include one or more pairs of the input data and the ground-truth data corresponding to the clean ground-truth data among multiple pairs of the input data and the ground-truth data belonging to the training data.

The linear layer parameter may indicate a parameter corresponding to a linear layer (or a linear probing module (LPM)) among a plurality of layers prepared in the foundation model. That is, the linear layer parameter may include weight values and bias values prepared in the linear layer.

In other words, the linear layer parameter may include at least some of the plurality of pre-trained parameters in the foundation model, and the linear layer parameter may be a parameter corresponding to the linear layer of the foundation model.

The adapter parameter may represent a parameter of an adapter loaded into at least some of the plurality of layers prepared in the foundation model. That is, the adapter parameter is prepared in the adapter, and different types of parameters may be included according to the operation method of the adapter. In an embodiment, the adapter may include visual prompt tuning (VPT), AdaptFormer, etc.

In other words, the adapter parameters may be parameters of adapters that are additionally loaded into the foundation model in addition to the plurality of pre-trained parameters in the foundation model. Meanwhile, according to an embodiment, the adapter parameter may be named as an intermediate adapter parameter. In this case, the adapter that includes the adapter parameter may be named as the intermediate adapter module (IAM).

In this regard, the fine-tuning system 100 may re-train additional adapter parameters other than the adapter parameters by using additional filtering data extracted from the filtering data.

Here, the additional filtering data may be data obtained by re-filtering the filtering data according to the predefined condition. That is, the additional filtering data may be composed of at least some data extracted from the filtering data. In this case, the predefined condition for extracting the additional filtering data from the filtering data may be predefined as the matching condition.

The additional adapter parameters may represent parameters of additional adapters loaded into at least some of the plurality of layers prepared in the foundation model. That is, the additional adapter parameters are prepared in the additional adapters, and different types of parameters may be included according to the operation method of the additional adapter, and the additional adapter may be prepared as adapters of the same type or different types from the adapters described above. That is, in an embodiment, the additional adapter may include the VPT, the AdaptFormer, etc.

Accordingly, the additional adapter parameters may be parameters of additional adapters additionally loaded into the foundation model in addition to the plurality of pre-trained parameters and the adapter parameters in the foundation model. According to an embodiment, the additional adapter parameter may be named as a last adapter parameter. In this case, the additional adapter that includes the additional adapter parameter may be named as a last adapter module (LAM).

Meanwhile, the fine-tuning system 100 may complete the fine-tuning of the foundation model by loading the additional adapter in which the additional adapter parameter has been pre-trained into the pre-trained foundation model.

In this case, the pre-trained foundation model may be a foundation model before the linear layer parameter, the adapter parameter, and the additional adapter parameter have been each trained according to the training data, the filtering data, and the additional filtering data, respectively, or may be a foundation model in which the linear layer parameter has been trained according to the training data.

Therefore, according to an embodiment, the fine-tuned foundation model may be a foundation model in which only the additional adapter has been trained according to the additional filtering data extracted based on the training data, or a foundation model in which the linear layer parameters according to the training data and the additional adapter parameter according to the additional filtering data have been trained.

Referring to FIG. 2, the fine-tuning system 100 according to the present invention may include an input unit 110, a storage unit 120, a control unit 130, and an output unit 140.

The information necessary for the operation of the fine-tuning system 100 according to the present invention may be input to the input unit 110. To this end, the input unit 110 may be connected to a separate input device, a server, an external storage device, etc., via a wireless or wired network.

Therefore, the input unit 110 may receive training data 10 from the separate input device, the server, the external storage device, etc. In addition, the input unit 110 may receive user input required while specifying a pre-trained foundation model 20 or fine-tuning the foundation model 20.

In addition, the storage unit 120 may store instructions and information necessary for the operation of the fine-tuning system 100 according to the present invention. For example, the storage unit 120 may store the pre-trained foundation model 20, and the training data 10 received (or prepared) to fine-tune the foundation model 20.

In addition, the storage unit 120 may store various information generated while fine-tuning the pre-trained foundation model 20. For example, the storage unit 120 may store the linear layer parameter, the adapter parameter, and the additional adapter parameter, and store the fine-tuned foundation model 20.

The control unit 130 may control the overall operation of the fine-tuning system 100 according to the present invention. That is, the control unit 130 may perform the fine-tuning on the pre-trained foundation model 20 using the training data 10. To this end, the control unit 130 may train the linear layer parameter of the pre-trained foundation model 20 using the training data 10, extract the filtering data from the training data 10 based on the foundation model 20 in which the linear layer parameter has been trained, and train the adapter parameter loaded into the foundation model 20 using the filtering data.

Specifically, the control unit 130 may confirm the training data 10 composed of input data and the ground-truth data labeled for the input data. That is, the control unit 130 may confirm the training data 10 prepared to fine-tune the pre-trained foundation model 20. In this case, the training data 10 may include the clean ground-truth data in which the output data output through the foundation model 20 in response to the input data and the ground-truth data have been labeled identically, and the noise ground-truth data in which the output data and the ground-truth data have been labeled differently.

Therefore, the control unit 130 may train the linear layer parameter of the pre-trained foundation model 20 using the training data 10. To this end, the control unit 130 may specify the linear layer parameter among the plurality of pre-trained parameters for the foundation model 20, and train the previously specified linear layer parameters based on the loss between the output data of the foundation model 20 according to the input data and the ground-truth data labeled for the input data.

In addition, the control unit 130 may extract the filtering data from the training data 10 in which the pair of the input data and the ground-truth data satisfies the predefined matching condition based on the foundation model 20 in which the linear layer parameter has been trained according to the training data 10.

That is, the control unit 130 may input the input data corresponding to the training data 10 to the foundation model 20 in which the linear layer parameter has been trained, compare the output data output from the foundation model 20 with the ground-truth data according to the input data, and generate the filtering data by extracting the pair of the input data and ground-truth data in which the output data and the ground-truth data match each other according to the comparison result.

Accordingly, the control unit 130 may train the adapter parameter for the foundation model 20 using the filtering data. To this end, the control unit 130 may specify a predefined adapter parameter for the foundation model 20 in which the linear layer parameter has been trained, input the input data of the filtering data generated based on the corresponding foundation model 20 to the corresponding foundation model 20, and train the previously specified adapter parameter based on the loss between the output data generated from the foundation model 20 according to the input data and the ground-truth data labeled for the corresponding input data.

Furthermore, the control unit 130 may extract additional filtering data in which the pair of the input data and the ground-truth data satisfies the predefined matching condition from the filtering data based on the foundation model 20 in which the adapter parameter has been trained according to the filtering data.

That is, the control unit 130 may input the input data corresponding to the filtering data to the foundation model 20 in which the adapter parameter has been trained, compare the output data output from the foundation model 20 with the ground-truth data according to the input data, and generate the additional filtering data by extracting the pair of the input data and the ground-truth data in which the output data and the ground-truth data match each other from the filtering data according to the comparison result.

Accordingly, the control unit 130 may train an additional adapter parameter for the foundation model 20 using the additional filtering data. To this end, the control unit 130 may specify a predefined additional adapter parameter for the foundation model 20 in which the adapter parameter has been trained, input, to the corresponding foundation model 20, the input data of the additional filtering data generated based on the corresponding foundation model 20, and train the previously specified adapter parameter based on the loss between the output data generated from the foundation model 20 according to the input data and the ground-truth data labeled for the corresponding input data.

In this way, the control unit 130 may complete the fine-tuning of the foundation model 20 by loading the additional adapter in which the pre-trained additional adapter parameter has been prepared into the pre-trained foundation model 20.

The output unit 140 may output information generated by the operation of the fine-tuning system 100 according to the present invention. To this end, the output unit 140 may be connected to a separate visual output device, a server, an external storage device, etc., via a wireless or wired network.

Therefore, the output unit 140 may output the training data, the linear layer parameter, the adapter parameter, and the additional adapter parameter, etc., so that the user may visually confirm the training data, the linear layer parameter, the adapter parameter, and the additional adapter parameter, etc., through the separate output device, the server, the external storage device, etc. According to an embodiment, the output unit 140 may transmit the training data, the linear layer parameter, the adapter parameter, and the additional adapter parameter, etc., to other devices. In addition, the output unit 140 may output various information generated while fine-tuning the pre-trained foundation model 20.

The fine-tuning method will be described in more detail below based on the configuration of the fine-tuning system 100 described above.

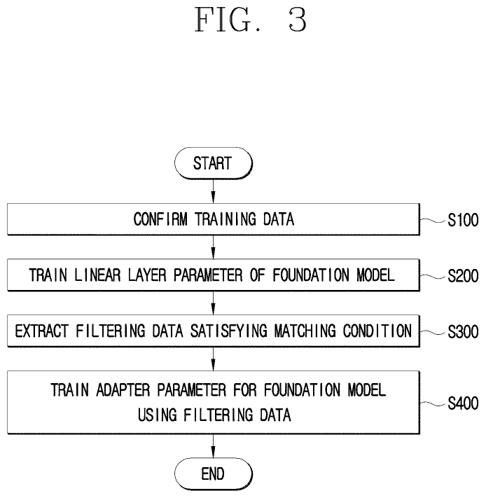

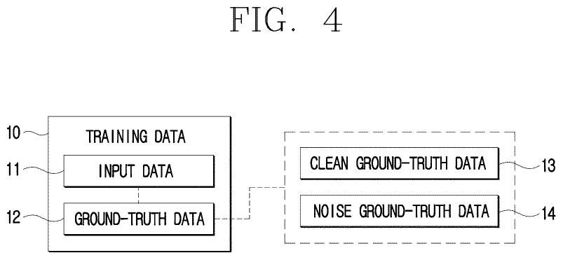

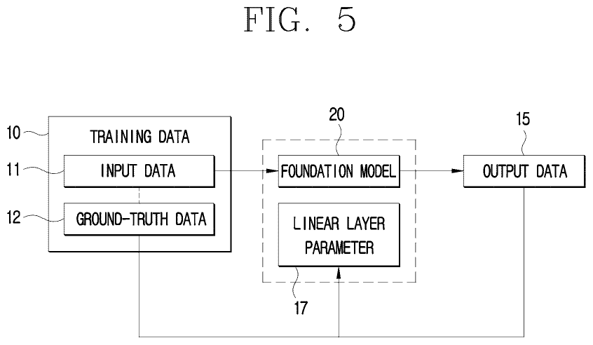

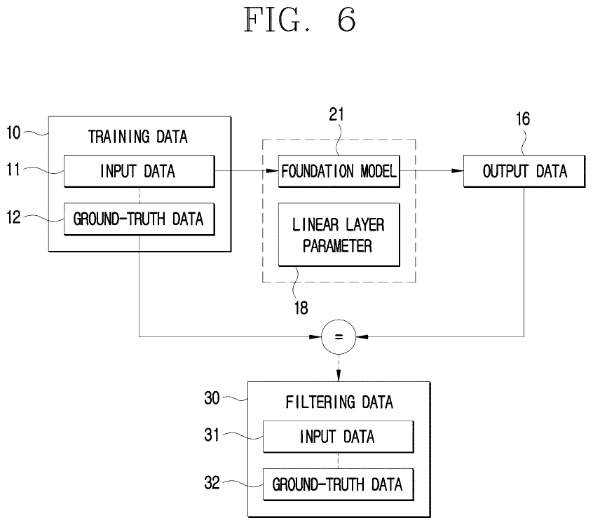

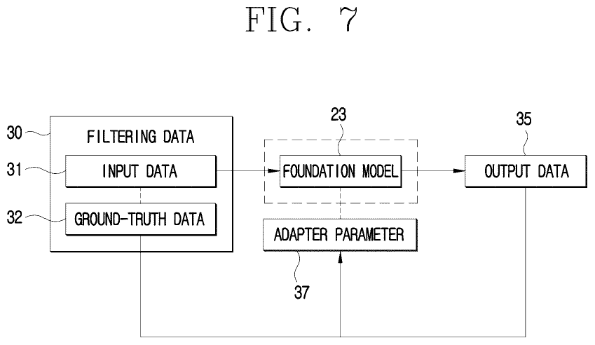

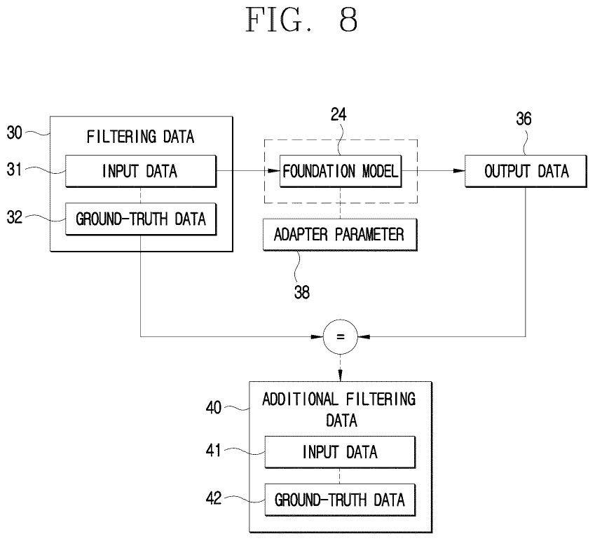

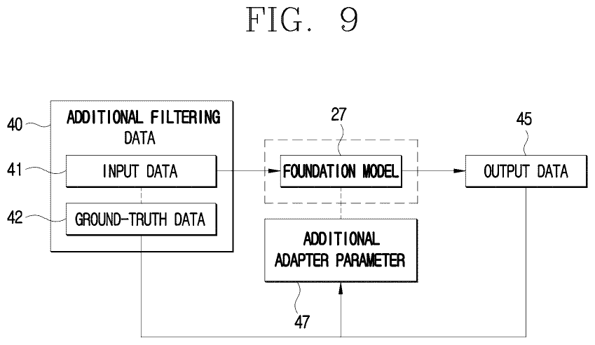

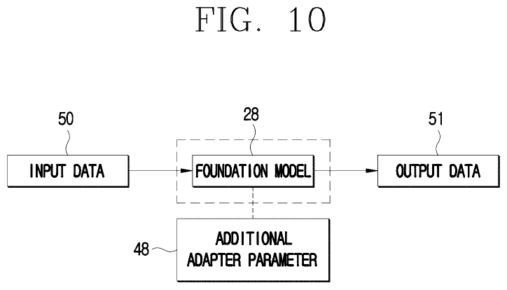

FIG. 3 is a flowchart illustrating a fine-tuning method according to the present invention. FIG. 4 illustrates an embodiment of the training data. FIG. 5 illustrates an embodiment of the training linear layer parameter. FIG. 6 illustrates an embodiment of extracting the filtering data. FIG. 7 illustrates an embodiment of training the adapter parameter. FIG. 8 illustrates an embodiment of extracting the additional filtering data. FIG. 9 illustrates an embodiment of training the additional adapter parameter. FIG. 10 illustrates an embodiment of the fine-tuned foundation model.

Referring to FIG. 3, the fine-tuning system 100 according to the present invention may confirm the training data composed of the input data and the ground-truth data labeled for the input data (S100).

Specifically, the fine-tuning system 100 may confirm the training data prepared to fine-tune the pre-trained foundation model. In this case, as illustrated in FIG. 4, the training data 10 may include the clean ground-truth data 13 in which the output data output through the foundation model in response to input data 11 and ground-truth data 12 have been labeled identically, and the noise ground-truth data 14 in which the output data and the ground-truth data 12 have been labeled differently.

For example, the fine-tuning system 100 may receive the training data 10 prepared to fine-tune the pre-trained foundation model according to the predefined field based on the large-scale training data. Here, the predefined field may mean a field which will acquire predetermined results through the foundation model.

In an embodiment, the training data 10 may be prepared to fine-tune the foundation model according to a medical field. In this case, the training data 10 may include the plurality of input data 11 corresponding to images obtained by capturing predetermined lesions, and include the plurality of ground-truth data 12 that are labeled for each of the plurality of input data 11 and has the names of the lesions corresponding to the input data 11 defined therein.

Referring again to FIG. 3, the fine-tuning system 100 according to the present invention may train the linear layer parameter of the pre-trained foundation model using the training data (S200).

Specifically, the fine-tuning system 100 may specify the linear layer parameter among the plurality of pre-trained parameters for the foundation model, and train the previously specified linear layer parameters based on the loss between the output data of the foundation model according to the input data and the ground-truth data labeled for the input data.

Referring to FIG. 5, for example, the fine-tuning system 100 may specify the linear layer including the weight values and the bias values among the plurality of layers prepared in the foundation model 20, and specify the weight values and the bias values prepared in the specified linear layer as a linear layer parameter 17.

Therefore, the fine-tuning system 100 may train the specified linear layer parameters 17 for the foundation model by using the pair of the input data 11 and the ground-truth data 12 included in the training data 10. That is, the fine-tuning system 100 may input the input data 11 to the foundation model 20 to acquire the output data 15 corresponding to the input data 11, and compare the acquired output data 15 with the ground-truth data 12 labeled for the input data 11 to calculate the loss of the foundation model 20.

Accordingly, the fine-tuning system 100 may train the foundation model 20 by correcting the linear layer parameter 17 based on the previously calculated loss. In an embodiment, the fine-tuning system 100 may train the foundation model 20 according to the following Equation 1.

$${min}_{{θ}_{LPM}} {{\sum }_{i = 1}}^{n} {L}_{ce} ( p ( {x}_{i} \vert {θ}_{VFM} , {θ}_{LPM} ) , {\hat{y}}_{i} ) \qquad [ Equation 1 ]$$

Here, θ_{LPM} represent the linear layer parameter 17, θ_{VFM} may represent the pre-trained parameter in the foundation model 20, L_{ce} may represent the loss (or loss function) of the foundation model 20, xᵢ may represent the input data 11, and ŷᵢ may represent the ground-truth data 12.

Referring back to FIG. 3, the fine-tuning system 100 according to the present invention may extract, from the training data, the filtering data in which the pair of the input data and the ground-truth data satisfies the predefined matching condition based on the foundation model in which the linear layer parameter has been trained according to the training data (S300).

Specifically, the fine-tuning system 100 may input the input data corresponding to the training data to the foundation model in which the linear layer parameter has been trained, compare the output data output from the foundation model with the ground-truth data according to the input data, and generate the filtering data by extracting the pair of the input data and the ground-truth data in which the output data and the ground-truth data match each other according to the comparison result.

Referring to FIG. 6, for example, the fine-tuning system 100 may input each of the plurality of input data 11 corresponding to the training data 10 to a foundation model 21 in which a linear layer parameter 18 has been trained using the training data 10 to acquire output data 16 corresponding to each of the plurality of input data 11.

Accordingly, the fine-tuning system 100 may compare each of the plurality of output data 16 with the ground-truth data 12 labeled for the input data 11 corresponding to each output data 16 to confirm whether there is any matching between the output data 16 and the ground-truth data 12.

In this regard, the training data 10 may be configured to have more clean ground-truth data than the noise ground-truth data. Therefore, it may be understood that the foundation model 21 trained using the training data 10 is trained to generate output data 16 corresponding to the clean ground-truth data for the predetermined input data 11.

Therefore, the fine-tuning system 100 may filter the training data 10 using the foundation model 21 trained based on the training data 10, that is, the fine-tuning system 100 may generate filtering data 30 by extracting a pair of input data 31 and ground-truth data 32 corresponding to the clean ground-truth data, excluding the pair of the input data and ground-truth data corresponding to the noise ground-truth data from the training data 10.

Referring back to FIG. 3 again, the fine-tuning system 100 according to the present invention may train the adapter parameter for the foundation model using the filtering data (S400).

Specifically, the fine-tuning system 100 may specify the predefined adapter parameter for the foundation model in which the linear layer parameter has been trained, input, to the corresponding foundation model, the input data of the filtering data generated based on the corresponding foundation model, and train the previously specified adapter parameter based on the loss between the output data generated from the foundation model according to the input data and the ground-truth data labeled for the corresponding input data.

Referring to FIG. 7, for example, the fine-tuning system 100 may add a predefined adapter to a foundation model 23 in which the linear layer parameter has been trained, and specify a parameter prepared in the additional adapter as an adapter parameter 37.

Therefore, the fine-tuning system 100 may confirm the pair of the input data 31 and the ground-truth data 32 in the filtering data 30 generated based on the foundation model 23 in which the linear layer parameter has been trained, and may train the adapter parameter 37 of the foundation model 23 to which the adapter has been added previously by using the confirmed pair of the input data 31 and the ground-truth data 32. That is, the fine-tuning system 100 may input the input data 31 according to the filtering data 30 to the foundation model 23 to which the adapter has been added to acquire output data 35 corresponding to the corresponding input data 31, and compare the acquired output data 35 with the ground-truth data 32 labeled for the input data 31 to calculate the loss of the foundation model 23 to which the adapter has been added. Accordingly, the fine-tuning system 100 may train the foundation model 23 to which the adapter has been added by correcting the adapter parameter 37 based on the previously calculated loss.

For another example, the fine-tuning system 100 may add the predefined adapter to the pre-trained foundation model and specify the parameter prepared in the additional adapter as the adapter parameter. Here, the pre-trained foundation model may represent the foundation model before the linear layer parameter has been trained based on the training data.

In this case, the fine-tuning system 100 may confirm the pair of the input data and the ground-truth data in the filtering data generated based on the foundation model in which the linear layer parameter has been trained, and train the adapter parameter of the foundation model to which the adapter has been added previously by using the confirmed pair of the input data and the ground-truth data.

That is, the fine-tuning system 100 may input the input data according to the filtering data to the foundation model to which the adapter has been added, acquire the output data corresponding to the corresponding input data, and compare the acquired output data with the ground-truth data labeled for the input data to calculate the loss of the foundation model to which the adapter has been added.

Accordingly, the fine-tuning system 100 may train the foundation model to which the adapter has been added by correcting the adapter parameter based on the previously calculated loss.

In an embodiment, the fine-tuning system 100 may train the foundation model to which the adapter has been added according to the following Equation 2.

$${min}_{{θ}_{IAM}} {{\sum }_{i = 1}}^{n} {L}_{ce} ( p ( {x}_{i} \vert {θ}_{VFM} , {θ}_{IAM} ) , {\hat{y}}_{i} ) 1 \{ arg max p ( {x}_{i} \vert {θ}_{VFM} , {θ}_{LPM} ) = {\hat{y}}_{i} \} \qquad [ Equation 2 ]$$

Here, θ_{IAM} may represent the adapter parameter. That is, the fine-tuning system 100 may extract the filtering data from the training data using the foundation model including the plurality of pre-trained parameters and the pre-trained linear layer parameter, and train the adapter parameter based on the loss according to the previously extracted filtering data for the pre-trained foundation model before the linear layer parameter has been trained.

Furthermore, the fine-tuning system 100 may extract additional filtering data in which the pair of the input data and the ground-truth data satisfies the predefined matching condition from the filtering data based on the foundation model in which the adapter parameter has been trained according to the filtering data.

That is, the fine-tuning system 100 may input the input data corresponding to the filtering data to the foundation model in which the adapter parameter has been trained, compare the output data output from the foundation model with the ground-truth data according to the input data, and generate the additional filtering data by extracting the pair of the input data and the ground-truth data in which the output data and the ground-truth data match each other from the filtering data according to the comparison result.

Referring to FIG. 8, for example, the fine-tuning system 100 may input each of the plurality of input data 31 corresponding to the filtering data 30 to the foundation model 24 in which the adapter parameter 38 has been trained using the filtering data 30 to acquire output data 36 corresponding to each of the plurality of input data 31.

Accordingly, the fine-tuning system 100 may compare each of the plurality of output data 36 with the ground-truth data 32 labeled for the input data 31 corresponding to each output data 36 to confirm whether there is any matching between the output data 36 and the ground-truth data 32.

Therefore, the fine-tuning system 100 may re-filter the filtering data 30 using the foundation model 24 trained based on the filtering data 30. That is, the fine-tuning system 100 may generate additional filtering data 40 by extracting a pair of input data 41 and ground-truth data 42 corresponding to the clean ground-truth data, excluding the pair of the input data and ground-truth data corresponding to the noise ground-truth data from the filtering data 30.

In this case, the foundation model 24 may be a model in which the linear layer parameter and the adapter parameter 38 have been sequentially trained, or a model in which only the adapter parameter 38 has been trained.

Furthermore, the fine-tuning system 100 may train additional adapter parameters for the foundation model using additional filtering data.

Specifically, the fine-tuning system 100 may specify the predefined additional adapter parameter for the foundation model in which the adapter parameter has been trained, input, to the corresponding foundation model, the input data of the additional filtering data generated based on the corresponding foundation model, and train the previously specified adapter parameter based on the loss between the output data generated from the foundation model according to the input data and the ground-truth data labeled for the corresponding input data.

Referring to FIG. 9, for example, the fine-tuning system 100 may add a predefined additional adapter to a foundation model 27 in which the adapter parameter has been trained, and specify a parameter prepared in the additional adapter as an additional adapter parameter 47.

Therefore, the fine-tuning system 100 may confirm the pair of the input data 41 and the ground-truth data 42 in the additional filtering data 40 generated based on the foundation model 27 in which the adapter parameter has been trained, and may train the additional adapter parameter 47 of the foundation model 27 to which the additional adapter has been added previously by using the confirmed pair of the input data 41 and the ground-truth data 42. That is, the fine-tuning system 100 may input the input data 41 according to the additional filtering data 40 to the foundation model 27 to which the additional adapter has been added to acquire output data 45 corresponding to the corresponding input data 41, and compare the acquired output data 45 with the ground-truth data 42 labeled for the input data 41 to calculate the loss of the foundation model 27 to which the additional adapter has been added.

Accordingly, the fine-tuning system 100 may train the foundation model 27 to which the additional adapter has been added by correcting the additional adapter parameter 47 based on the previously calculated loss.

For another example, the fine-tuning system 100 may add the predefined additional adapter to the pre-trained foundation model, and specify the parameter prepared in the additional adapter as the additional adapter parameter. Here, the pre-trained foundation model may represent the foundation model before the linear layer parameter and the adapter parameter have been each trained based on the training data.

In this case, the fine-tuning system 100 may confirm the pair of the input data and the ground-truth data in the additional filtering data generated based on the foundation model in which the adapter parameter has been trained, and train the additional adapter parameter of the foundation model to which the additional adapter has been added previously by using the confirmed pair of the input data and the ground-truth data.

That is, the fine-tuning system 100 may input the input data according to the filtering data to the foundation model to which the additional adapter has been added, acquire the output data corresponding to the corresponding input data, and compare the acquired output data with the ground-truth data labeled for the input data to calculate the loss of the foundation model to which the additional adapter has been added.

Accordingly, the fine-tuning system 100 may train the foundation model to which the additional adapter has been added by correcting the additional adapter parameter based on the previously calculated loss.

In an embodiment, the fine-tuning system 100 may train the foundation model to which the additional adapter has been added according to the following Equation 3.

$${min}_{{θ}_{LAM}} {{\sum }_{i = 1}}^{n} {L}_{ce} ( p ( {x}_{i} \vert {θ}_{VFM} , {θ}_{LAM} ) , {\hat{y}}_{i} ) 1 \{ arg max p ( {x}_{i} \vert {θ}_{VFM} , {θ}_{IAM} ) = {\hat{y}}_{i} \} \qquad [ Equation 3 ]$$

Here, θ_{LAM} may represent the additional adapter parameter. That is, the fine-tuning system 100 may extract the additional filtering data from the training data using the foundation model including the plurality of pre-trained parameters and the pre-trained adapter parameter, and train the additional adapter parameter based on the loss according to the previously extracted additional filtering data for the pre-trained foundation model before the linear layer parameter and the adapter parameter have been each trained.

Furthermore, the fine-tuning system 100 may complete the fine-tuning of the foundation model by loading the additional adapter in which the pre-trained additional adapter parameter has been prepared into the pre-trained foundation model.

Referring to FIG. 10, for example, the fine-tuning system 100 may load an additional adapter in which a pre-trained additional adapter parameter 48 has been prepared into the foundation model before the linear layer parameter, the adapter parameter, and the additional adapter parameter 48 have been each trained, according to the training data, the filtering data, and the additional filtering data, respectively. Accordingly, the fine-tuning system 100 may provide the foundation model 28 into which the additional adapter is loaded as the fine-tuned foundation model 28.

Accordingly, when predetermined input data 50 is input, the foundation model 28 may generate output data 51 based on the plurality of pre-trained parameters in the foundation model 28 and the additional adapter parameters 48 according to the additional adapter.

For another example, the fine-tuning system 100 may load the additional adapter in which the pre-trained additional adapter parameter has been prepared into the foundation model in which the linear layer parameter has been trained according to the training data. That is, the fine-tuning system 100 may provide, as the fine-tuned foundation model, the foundation model trained with the training data and the additional filtering data, excluding the adapter trained based on the filtering data.

Through the above configurations, the fine-tuning system 100 according to the present invention may perform the fine-tuning on the pre-trained foundation model so that the pre-trained foundation model may be used as the vision-based model for the specific field based on the large-scale training data by training the linear layer parameter and the adapter parameter of the pre-trained foundation model using the training data for the specific field.

In addition, the fine-tuning system 100 according to the present invention may filter the noise ground-truth data from the training data containing noise and train the linear layer parameter and the adapter parameter step-by-step, thereby providing a more powerful fine-tuned learning model for the specific field corresponding to the training data.

Furthermore, the fine-tuning system 100 according to the present invention may be implemented through a computing device described below and perform the data processing related to the fine-tuning method described above.

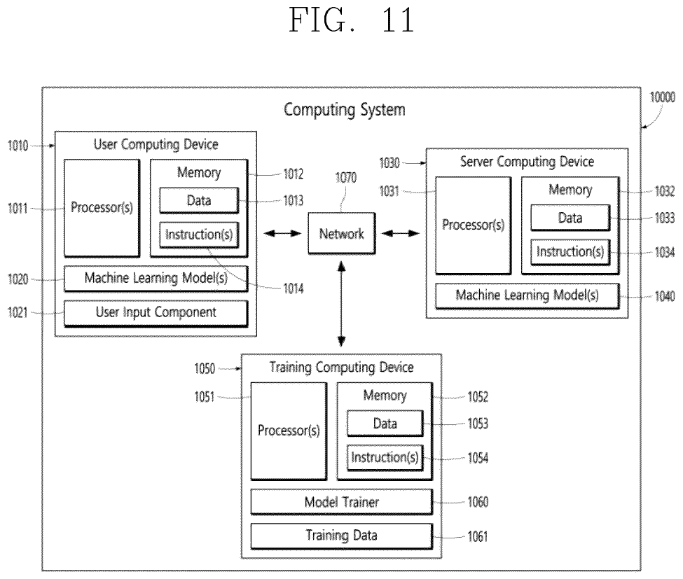

Meanwhile, FIG. 11 illustrates an example block diagram of a computing system in which the present invention may be implemented.

Referring to FIG. 11, a computing system (10000) for performing a method for fine-tuning vision foundation models that can utilize training data containing label noise according to an embodiment of the present invention may include at least one computing device. In this case, the at least one computing device may be a single-processor or multi-processor computing apparatus.

The components of the at least one computing device of the present invention may include one or more processors, memory, other hardware, and various system components connected (e.g., communicatively, physically, or electrically connected) via a system bus (not shown) that enables data to be transmitted and received among them. The components of the at least one computing device are not limited thereto and may vary widely.

Meanwhile, the at least one computing device included in the computing system (10000) that performs a method for fine-tuning vision foundation models that can utilize training data containing label noise may be communicatively connected via a network (1070). For example, the at least one computing device included in the computing system (10000) may be clustered or may be part of a local area network (LAN). Additionally, the at least one computing device may be part of a wide area network (WAN) or connected via at least one of a client-server network or a peer-to-peer network in a cloud environment.

Meanwhile, when the at least one computing device is used in at least one environment among a network environment and a cloud computing environment, the at least one computing device may be connected to at least one of a public network and a private network through a network interface or adapter. In an embodiment, other communication connection devices, such as a modem, may be used to establish communication over the network. The modem may be at least one of an internal modem and an external modem and may be connected to the system bus through a network interface or a specific mechanism. A wireless network component comprising an interface and an antenna may be coupled to the network through devices such as access points or peer computers. In the present invention, the method by which the at least one computing device is communicatively connected via the network (1070) is not limited thereto and may be implemented by means other than the examples described above.

Furthermore, other computer-type devices and/or systems not illustrated in FIG. 11 may technically interact with the at least one computing device or other systems through one or more connections to the network (1070) via a network interface. Here, the network interface may include network interface equipment such as a physical Network Interface Controller (NIC) or a Virtual Interface (VIF).

The network (1070) of the present invention may include various types of networks such as the Internet, Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), 5th Generation Mobile Telecommunication (5G), Bluetooth™, Radio Frequency Identification (RFID), Infrared Data Association (IrDA), Ultra-Wideband (UWB), ZigBee, Near Field Communication (NFC), Wireless Universal Serial Bus (Wireless USB), and the like. In the present invention, data transmission may be performed based on standard communication protocols such as TCP/IP, HTTP, SSL, and others.

The computing system (10000) for performing a method for fine-tuning vision foundation models that can utilize training data containing label noise according to the present invention may include at least one of a user computing device (1010), a training computing device (1050), and a server computing devise (1030).

The user computing device (1010) according to the present invention may be understood as a computing device including at least one processor (1011) and memory (1012) for performing a method for fine-tuning vision foundation models that can utilize training data containing label noise. For example, the user computing device (1010) may include at least one computing device selected from among a smart phone, smart TV, laptop computer, desktop computer, digital broadcasting terminal, personal digital assistant (PDA), portable multimedia player (PMP), navigation device, slate PC, tablet PC, ultrabook, and wearable device (e.g., smartwatch, smart glass, and head-mounted display (HMD)).

The at least one processor (1011) constituting the user computing device (1010) may include one or more general-purpose processors and/or one or more special-purpose processors. For example, the at least one processor (1011) of the user computing device (1010) may include at least one or a combination of electrically connected processors selected from the group consisting of: a Central Processing Unit (CPU), a Graphics Processing Unit (GPU), a Tensor Processing Unit (TPU), a Neural Processing Unit (NPU), an Arithmetic Logic Unit (ALU), a Floating Point Unit (FPU), an Application-Specific Integrated Circuit (ASIC), a digital signal processing device (DSPD), a programmable logic device (PLD), a Field Programmable Gate Array (FPGA), a controller, a microcontroller, a microprocessor, and other electrical units for performing specific functions.

Furthermore, the at least one processor (1011) may be configured to execute computer-readable instructions stored in the memory (1012) and/or other commands described in the present specification.

The memory (1012) constituting the user computing device (1010) according to the present invention may include volatile memory, non-volatile memory, fixed media, removable media, magnetic media, optical media, semiconductor media, and/or other types of physically durable storage media.

For example, the memory (1012) may include one or more non-transitory/transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs the memory storage function over the Internet.

The memory (1012) may store data and instructions necessary for the at least one processor (1011) to perform operations of an application for fine-tuning vision foundation models that can utilize training data containing label noise.

The user computing device (1010) may include one or more user input components (1021) configured to detect user input. For example, the user input component (1021) may also be referred to as a user interface module. The user input component (1021) may include devices such as a touch screen, computer mouse, keyboard, keypad, touchpad, trackball, joystick, voice recognition module, or other similar devices. However, the present invention does not limit the types of the user input component (1021).

In this context, the user input component (1021) in the present invention is not necessarily limited to a hardware means but may be understood as a channel through which input is received from a user.

Meanwhile, the “user” in the present invention may also refer to an automated agent, script, playback software, or the like that operates on behalf of one or more human users.

A user may interact with the computing system (10000), which includes at least one computing device, through the user input component (1021) using inputted text, touch, voice, motion, computer vision, gesture, and/or other forms of input/output. For example, the user input component (1021) may include one or more user interface (UI) modalities such as a Command Line Interface (CLI), Graphical User Interface (GUI), Natural User Interface (NUI), voice command interface, and/or other UI representations.

One or more Application Programming Interface (API) calls may be made between the user input component (1021) and the user computing device (1010), based on user input received through a user interface and/or from a network.

Herein, the phrase “based on” may be interpreted to include instances where a particular configuration is used as a foundation, modified from, derived from, influenced by, dependent on, or otherwise originating from such configuration.

In some embodiments, the API call may be configured for a specific API and may be interpreted as, or converted into, an API call configured for a different API. In this context, the API may refer to a defined interface or connection between computers or between computer programs.

In an embodiment, the user computing device (1010) may store one or more machine learning models (1020). For example, the user computing device (1010) may include various machine learning models, such as multiple neural networks (e.g., deep neural networks) for performing fine-tuning of vision foundation models that can utilize training data containing label noise, the training data comprising input data and corresponding ground-truth labels, or other types of machine learning models including nonlinear models and/or linear models, or may be configured as a combination thereof.

According to an embodiment of the present invention, the user computing device (1010) may perform a method for fine-tuning vision foundation models that can utilize training data containing label noise by using a local and/or external machine learning model (1020). Alternatively, the user computing device (1010) may perform the method for fine-tuning vision foundation models that can utilize training data containing label noise by using a machine learning model (1040) provided by a server.

According to another embodiment of the present invention, a server computing device (1030) communicating with the user computing device (1010) may train adapter parameters for a foundation model in response to a user request received through the user computing device (1010).

According to yet another embodiment of the present invention, at least a portion of the user computing device (1010) and the server computing device (1030) may be cooperatively operated to perform a method for fine-tuning vision foundation models that can utilize training data containing label noise, thereby training adapter parameters for the foundation model.

According to various embodiments of the present invention, the user computing device (1010) and/or the server computing device (1030) may train the machine learning models (1020, 1040) used in the method for fine-tuning vision foundation models that can utilize training data containing label noise through interaction with a training computing device (1050) that is communicatively connected via the network (1070).

In this case, the training computing device (1050) may be a computing system separate from the server computing device (1030). Alternatively, in some embodiments, the training computing device (1050) may be a part of the server computing device (1030) or a part of the user computing device (1010).

Meanwhile, the server computing device (1030) may include at least one processor (1031) and memory (1032). Here, the processor (1031) may include at least one or a combination of electrically connected processors selected from among: a Central Processing Unit (CPU), Graphics Processing Unit (GPU), Tensor Processing Unit (TPU), Neural Processing Unit (NPU), Application-Specific Integrated Circuit (ASIC), Arithmetic Logic Unit (ALU), Floating Point Unit (FPU), digital signal processing devices (DSPDs), programmable logic devices (PLDs), Field Programmable Gate Arrays (FPGAs), controllers, microcontrollers, microprocessors, and/or other electrical units for performing specific functions. For example, the at least one processor (1031) may include circuits and transistors configured to execute instructions from the memory (1032).

The memory (1032) constituting the server computing device (1030) according to the present invention may include volatile memory, non-volatile memory, fixed media, removable media, magnetic media, optical media, semiconductor media, and/or other types of physically durable storage media.

For example, the memory (1032) may include one or more transitory/non-transitory computer-readable storage media, or combinations thereof, such as Random Access Memory (RAM), Read Only Memory (ROM), Hard Disk Drive (HDD), Solid State Disk (SSD), Silicon Disk Drive (SDD), Electrically Erasable Programmable Read-Only Memory (EEPROM), Erasable Programmable Read-Only Memory (EPROM), flash memory devices, and magnetic disks. It may also include web storage of a server that performs memory storage functions over the Internet.

Additionally, the server computing device (1030) may further include a data store. For example, the data store may be configured as at least one of a relational database, a NoSQL database, a data warehouse, and a local file system.

The memory (1032) constituting the server computing device (1030) according to the present invention may store data and instructions necessary for the at least one processor (1031) to perform operations of an application for fine-tuning vision foundation models that can utilize training data containing label noise.

In an embodiment, the server computing device (1030) may be configured as a single device or as a plurality of computing devices, which may be configured to operate according to a sequential or parallel computing architecture. Additionally, the system may be implemented as a distributed processing system comprising multiple devices connected over a network.

Meanwhile, the training computing device (1050) may include at least one processor (1051) and memory (1052). A model trainer (1060), as a logical component that performs training of at least one machine learning model (1020, 1040), may be implemented in the form of hardware, firmware, or software.

For example, the model trainer (1060) may load training data (1061) stored in a storage device into the memory (1052), and then be executed by the processor (1051). The model trainer (1060) may be configured to perform one or more operations-such as model training, model reconstruction, model validation, and model testing-on at least one machine learning model.

The machine learning model according to the present invention may include at least one of the following: a statistical model, an algorithm, a neural network (NN), a convolutional neural network (CNN), a generative neural network (GNN), a Word2Vec model, a Bag of Words model, a Term Frequency-Inverse Document Frequency (TF-IDF) model, a Generative Pre-trained Transformer (GPT) model (or other autoregressive models), a Proximal Policy Optimization (PPO) model, a nearest neighbor model (e.g., k-nearest neighbor model), a linear regression model, a k-means clustering model, a Q-learning model, a Temporal Difference (TD) model, a Deep Adversarial Network model, and any other type of model described in the present specification.

Specifically, the model trainer (1060) may perform operations for training a machine learning model, and the operations may include at least one of adding, removing, and modifying model parameters. In this case, the training of the machine learning model may be at least one of supervised learning, semi-supervised learning, and unsupervised learning.

In an embodiment, training of the machine learning model may include a step of repeatedly inputting the training data (1061) based on epochs, and iteratively performing the machine learning model learning process configured in this manner. Here, an epoch may refer to a unit representing one complete forward and backward pass of the entire training data (1061) set.

In some implementations, different learning methods (e.g., supervised learning, semi-supervised learning, and unsupervised learning) may be applied at different epochs.

The training data (1061) of the present invention may include input data and/or data previously output from at least one machine learning model (e.g., recursive learning feedback).

The parameters of the at least one machine learning model may include at least one of a seed value, model nodes, model layers, algorithms, functions, connections between different machine learning models, connections between parameters, constraints of the machine learning model, and other digital components that influence the output of the machine learning model.

In this case, a model connection between different machine learning models may include or represent relationships between model parameters and/or between models, which may be dependent, interdependent, hierarchical, and/or static or dynamic.

The combination and configuration of the model parameters described herein may be too complex to be maintained or utilized by human cognitive capabilities.

The present invention does not limit the parameters of machine learning models to those described in the embodiments, and a single machine learning model may include a plurality of model parameters.

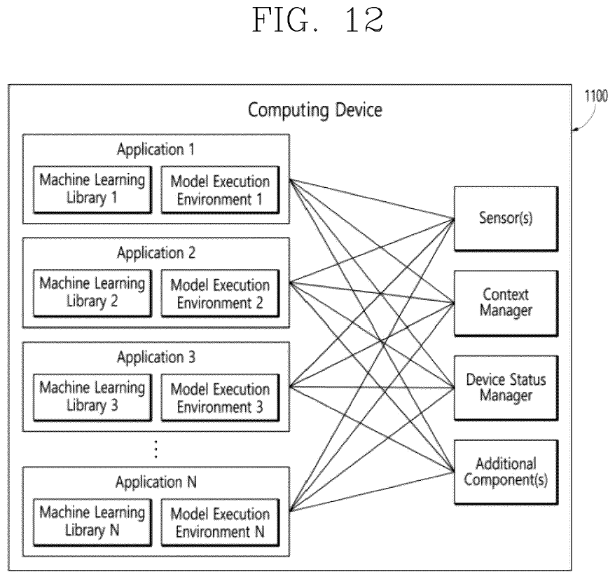

Meanwhile, FIG. 12 illustrates an example block diagram of a computing device (1100), which may be included in the user computing device (1010), the server computing device (1030), or the training computing device (1050), as an embodiment of the computing system (10000) in which the present invention may be implemented.

As shown in FIG. 12, the computing device (1100) may include at least one application (e.g., Application 1 to Application N), and each of the at least one application may include a machine learning library and a model execution environment for performing a method for fine-tuning vision foundation models that can utilize training data containing label noise using machine learning.

Each of the at least one application included in the computing device (1100) may communicate via an Application Programming Interface (API) with one or more components within the computing device (1100), such as sensors, a context manager, a device state manager, or additional components.

In an embodiment, the at least one application may interface with device components by, for example, receiving sensor data or state data via a public or dedicated API, or transmitting prediction results to an output device.

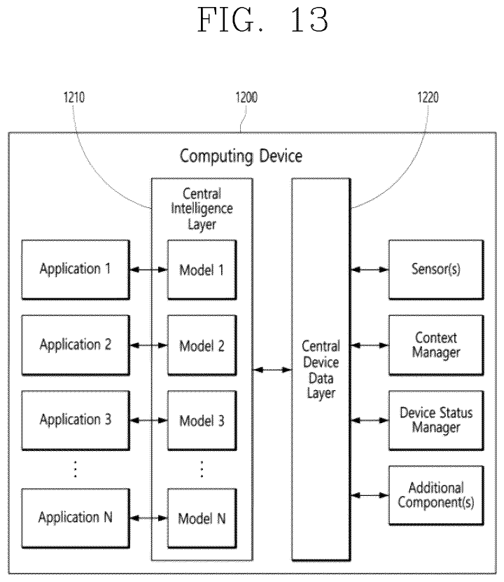

Meanwhile, FIG. 13 illustrates an example block diagram of a computing device (1200), which is one component of the computing system (10000) performing the method for fine-tuning vision foundation models that can utilize training data containing label noise according to an embodiment of the present invention, from another perspective.

The computing device (1200) according to the present invention may include at least one application (e.g., Application 1 to Application N), and each of the at least one application may communicate with a central intelligence layer (1210). Each application may interact with a shared model within the central intelligence layer (1210) via an API (e.g., a common API).

The central intelligence layer (1210) may include one or more machine learning models and may either share them among multiple applications or provide them independently to each application. In an embodiment, the central intelligence layer (1210) may be integrated as part of the operating system or implemented as a separate logical layer.

Additionally, the central intelligence layer (1210) may communicate with a central device data layer (1220). The central device data layer (1220) may integratively store training data comprising input data and corresponding ground-truth labels stored within the computing device (1200) and provide such data as input required for fine-tuning vision foundation models that can utilize training data containing label noise. Each device component (e.g., sensors, state managers, etc.) may communicate with the central device data layer (1220) via a private API or the like.

The technology described in the present specification may be implemented using a single computing device or multiple computing devices. A machine learning model for performing a method for fine-tuning vision foundation models that can utilize training data containing label noise may be executed sequentially or in parallel on a single component or across multiple distributed components. The data store, machine learning models, and applications may be distributed and operated locally or over a network, and these components may be flexibly applied to various system architectures.

Meanwhile, in the above description, the fine-tuning system 100 according to the present invention has been described as being implemented as a computing system, but the present invention is not limited thereto. For example, the functions of the neural network and/or the computing device may be distributed among a plurality of computing clusters.

In addition, the present invention described above may be implemented as a program that is executed by one or more processors in the electronic device and stored in the computer-readable recording medium.

Therefore, the present invention can be implemented as a computer-readable code or instruction in the medium in which the program is recorded. That is, various control methods according to the present invention may be provided in the form of an integrated or individual program.

Meanwhile, the computer-readable medium includes all types of recording devices in which data that can be read by the computer system is stored. An example of the computer-readable medium may include a hard disk drive (HDD), a solid state disk (SSD), a silicon disk drive (SDD), a ROM, a RAM, a CD-ROM, a magnetic tape, a floppy disk, an optical data storage device, etc.

Furthermore, the computer-readable medium may be a server or cloud storage that includes storage and that the electronic device may access through communication. In this case, the computer may download the program according to the present invention from the server or cloud storage through wired or wireless communication.

Furthermore, in the present invention, the computer described above is an electronic device equipped with a processor, that is, a central processing unit (CPU), and there is no particular limitation on its type.

Meanwhile, the above-described detailed description is to be interpreted as being illustrative rather than being restrictive in all aspects. The scope of the present invention is to be determined by reasonable interpretation of the claims, and all modifications within an equivalent range of the present invention fall in the scope of the present invention.

What is claimed is:

1. A fine-tuning method processed by a computing device, comprising:
confirming training data composed of input data and ground-truth data labeled for the input data;
training a linear layer parameter of a pre-trained foundation model using the training data;
extracting, from the training data, filtering data in which a pair of the input data and the ground-truth data satisfies a predefined matching condition, based on the foundation model in which the linear layer parameter is trained according to the training data; and
training an adapter parameter for the foundation model using the filtering data.

2. The fine-tuning method of claim 1, further comprising:
extracting, from the filtering data, additional filtering data in which the pair of the input data and the ground-truth data satisfies the predefined matching condition based on the foundation model in which the adapter parameter is trained according to the filtering data.

3. The fine-tuning method of claim 2, further comprising:
training an additional adapter parameter for the foundation model using the additional filtering data.

4. The fine-tuning method of claim 3, further comprising:
completing the fine-tuning of the foundation model by loading an additional adapter in which the trained additional adapter parameter is prepared into the pre-trained foundation model.

5. The fine-tuning method of claim 1, wherein the training of the linear layer parameter includes:
specifying the linear layer parameter among a plurality of pre-trained parameters for the foundation model; and
training the specified linear layer parameter based on a loss between output data of the foundation model according to the input data and the ground-truth data labeled for the input data.

6. The fine-tuning method of claim 1, wherein the extracting of the filtering data includes:
receiving the input data corresponding to the training data to the foundation model in which the linear layer parameter is trained;
comparing output data output from the foundation model according to the input data with the ground-truth data; and
generating the filtering data by extracting a pair of the input data and the ground-truth data in which the output data and the ground-truth data match each other according to a comparison result.

7. The fine-tuning method of claim 1, wherein the training of the adapter parameter includes:
specifying the adapter parameter predefined for the foundation model;
receiving the input data of the filtering data generated based on the foundation model in which the linear layer parameter is trained to the foundation model; and
training the specified adapter parameter based on a loss between output data, generated from the foundation model according to the input data, and the ground-truth data labeled for the input data.

8. The fine-tuning method of claim 1, wherein the training data includes:
clean ground-truth data in which output data output through the foundation model in response to the input data and the ground-truth data are labeled identically; and
noise ground-truth data in which the output data and the ground-truth data are labeled differently.

9. A fine-tuning system, comprising:
a storage unit storing training data composed of input data and ground-truth data labeled for the input data; and
a control unit performing fine-tuning on a pre-trained foundation model using the training data,
wherein the control unit trains a linear layer parameter of the pre-trained foundation model using the training data, extracts, from the training data, filtering data in which a pair of the input data and the ground-truth data satisfies a predefined matching condition, based on the foundation model in which the linear layer parameter is trained according to the training data, and trains an adapter parameter for the foundation model using the filtering data.

10. The fine-tuning system of claim 9,
wherein the control unit is further configured to extract, from the filtering data, additional filtering data in which the pair of the input data and the ground-truth data satisfies the predefined matching condition based on the foundation model in which the adapter parameter is trained according to the filtering data.

11. The fine-tuning system of claim 10,
wherein the control unit is configured to train an additional adapter parameter for the foundation model using the additional filtering data.

12. The fine-tuning system of claim 11,
wherein the control unit is configured to complete the fine-tuning of the foundation model by loading an additional adapter, in which the trained additional adapter parameter is prepared, into the pre-trained foundation model.

13. The fine-tuning system of claim 9,
wherein the control unit is configured to train the linear layer parameter by:
specifying the linear layer parameter among a plurality of pre-trained parameters for the foundation model; and
training the specified linear layer parameter based on a loss between output data of the foundation model according to the input data and the ground-truth data labeled for the input data.

14. The fine-tuning system of claim 9,
wherein the control unit is configured to extract the filtering data by:
receiving input data corresponding to the training data into the foundation model in which the linear layer parameter is trained;
comparing output data output from the foundation model according to the input data with the ground-truth data; and
generating the filtering data by extracting a pair of the input data and the ground-truth data in which the output data and the ground-truth data match each other according to a comparison result.

15. A program stored in a non-transitory computer-readable storage medium, executed by one or more processes in an electronic device, wherein the program includes instructions to perform:
confirming training data composed of input data and ground-truth data labeled for the input data;
training a linear layer parameter of a pre-trained foundation model using the training data;
extracting, from the training data, filtering data in which a pair of the input data and the ground-truth data satisfies a predefined matching condition, based on the foundation model in which the linear layer parameter is trained according to the training data; and
training an adapter parameter for the foundation model using the filtering data.

16. The non-transitory computer-readable storage medium of claim 15,
wherein the instructions, when executed by the one or more processors, cause the one or more processors to extract, from the filtering data, additional filtering data in which the pair of the input data and the ground-truth data satisfies the predefined matching condition based on the foundation model in which an adapter parameter is trained according to the filtering data.

17. The non-transitory computer-readable storage medium of claim 16,
wherein the instructions, when executed by the one or more processors, cause the one or more processors to train an additional adapter parameter for the foundation model using the additional filtering data.

18. The non-transitory computer-readable storage medium of claim 17,
wherein the instructions, when executed by the one or more processors, cause the one or more processors to complete the fine-tuning of the foundation model by loading an additional adapter, in which the trained additional adapter parameter is prepared, into the pre-trained foundation model.

19. The non-transitory computer-readable storage medium of claim 15,
wherein the instructions, when executed by the one or more processors, cause the one or more processors to train the linear layer parameter by:
specifying the linear layer parameter among a plurality of pre-trained parameters for the foundation model; and
training the specified linear layer parameter based on a loss between output data of the foundation model according to the input data and the ground-truth data labeled for the input data.

20. The non-transitory computer-readable storage medium of claim 15,
wherein the instructions, when executed by the one or more processors, cause the one or more processors to extract the filtering data by:
receiving input data corresponding to the training data into the foundation model in which the linear layer parameter is trained;
comparing output data output from the foundation model according to the input data with the ground-truth data; and
generating the filtering data by extracting a pair of the input data and the ground-truth data in which the output data and the ground-truth data match each other according to a comparison result.
